(19) United States
(12) Patent Application Publication
(10) Pub. No.: US 2003/0225857 A1
(43) Pub. Date: Dec. 4, 2003

(54) Dissemination bus interface

(76) Inventors: Edward N. Flynn, Newton, CT (US); Ching-Sheng Buu, Seymour, CT (US); Brian Moore, Norwalk, CT (US); Edward A. Perrault, Westport, CT (US); Kenneth M. Richmond, Fairfield, CT (US)

Correspondence Address: FISH & RICHARDSON PC, 225 FRANKLIN ST, BOSTON, MA, 02110, US

(21) Appl. No.: 10/219,444

(22) Filed: Aug. 15, 2002

Related U.S. Application Data
(60) Provisional application No. 60/385,988, filed on Jun. 5, 2002.
(60) Provisional application No. 60/385,979, filed on Jun. 5, 2002.

(51) Int. Cl. G06F 15/16

(52) U.S. Cl. 709/217

(57) ABSTRACT

A system for disseminating data includes a gateway server, a processing module coupled to the gateway server requests data on a subject to be sent to a subscriber application, and a communications module for receiving a message from upstream network gateway servers, subscribing downstream gateway servers to receive the message, and broadcasting the message to the downstream gateway servers. The new system and methods provide a common mechanism for consolidating and disseminating data to all downstream applications. This enables the use of one message format for like events from different hosts and provides a consolidated mechanism for data and information exchange.

### RELATED APPLICATIONS

This application claims the priority of U.S. Provisional Patent Application No. 60/385,988, entitled “Security Processor,” filed Jun. 5, 2002, and U.S. Provisional Patent Application No. 60/385,979, entitled “Supermontage Architecture,” filed Jun. 5, 2002.

### BACKGROUND OF THE INVENTION

This invention relates to hardware and software communication systems for managing and distributing data between local and remote data sources.

Financial institutions and equity market systems require a robust information and data distribution system to send real-time market data (e.g., securities data) to professional traders and individual investors via a network. For instance, for institutions who operate the world's largest stock market network traffic can be significantly reduced by broadcasting a single message, or stock price, that instantaneously makes its way through the network to millions of market users.

### SUMMARY

According to an aspect of this invention, a system for disseminating data includes a gateway server having cache memory, a processing module coupled to the gateway server for making a subscription request requesting data on a subject to be sent to a subscriber application, and a communications module for receiving messages, subscribing servers to receive the message, and broadcasting the message to the downstream servers.

One or more of the following features may also be included. The communications module is a bus interface between the upstream gateway servers and the downstream servers.

The system also includes an intermediary software component with functions invoked by the intermediary software component to perform data exchange functions.

In certain embodiments, the bus interface includes subroutines for data message formatting. Further, the bus interface includes subject-based addressing.

As another feature, the message includes quote data. The message may also include aggregate quote data.

As yet another feature, the upstream network gateway servers includes messages formatted into fixed format data structures. The upstream network gateway servers broadcast the message. And the system also includes self describing messages mapped from fixed format data structure messages.

According to a further aspect of this invention, a dissemination process includes receiving a message from upstream network gateway servers, subscribing downstream gateway servers to receive the message, and broadcasting the message to the downstream gateway servers.

One or more of the following features may also be included. The message includes quote data. The message may also include aggregate quote data, or order data. The upstream network gateway servers format the message into fixed format data structures. And the upstream network gateway servers push the message to be broadcast.

As another feature, the process also includes mapping the fixed format data structure messages into self describing messages. The self describing messages include textual information.

As yet another feature, the process includes transmitting the message from the upstream network gateway servers to a broadcast consolidation server. The broadcast consolidation server broadcasts the message to the downstream gateway servers, which can include workstation applications.

One or more aspects of the invention may provide one or more of the following advantages.

The new system and methods allow the growth in networked-based distributed computing environments by providing efficient mechanisms by which to share information. In particular, the new system and methods offer a networked communication technology with various “multicast” capabilities without the cumbersome need to have a point-to-point dedicated connection between a source of information (publisher) and a destination (sink) to send and receive data.

In addition, the new system and methods allow a data source to publish data, which is encoded by “subject,” such that data sinks can subscribe to information by data type as opposed to a specific data source. The new system and methods also provide for efficient implementation of middleware in a message distribution system to provide the ability for data sources (publishers) to send data and for data sinks (subscribers) to request data by any subject type.

In general, the new system and methods also provide for rapid integration of quotes, orders, summary orders for security trading. Display quotes can reflect aggregation of all individual quotes & orders at each price.

The new system and methods also provide for separation of host application functions (i.e., orders, executions) from support functions (i.e., scans, dissemination). Accordingly, the new system and methods allow efficient downstream publication and data dissemination to all downstream users and services all downstream data requirements.

Additionally, improved performance of the security market is achieved. High transaction rates, which are achieved in part through use of memory structures instead of disk files in key components is critical for data dissemination. Another significant benefit is the predictable response time for downstream users by eliminating architectural bottlenecks in middleware. With the new system and methods, support functions are relocated away from the host to reduce processor and I/O contention.

Further, the new system and methods provide a common mechanism for consolidating and disseminating data to downstream applications. The new system and methods enable the use of one message format for like events from different hosts to provide a consolidated mechanism for data and information exchange.

Another benefit is the opportunity for component reuse in the areas of publishing or subscription of information and data. All data available on the same infrastructure may have differing subject titles and yet not affect the efficient dissemination of data. The use of publish/subscribe technologies in the security processing system and architecture enables mission-critical real-time messaging needed to create a robust infrastructure to provide traders and investors alike with more information and a more efficient means to act on that information.

Another beneficial result is the added efficiency and simplified configuration of the dynamic, source-based routing protocol when using the new system and methods. In addition, network users receive customized information sent to downstream users without having to query computer databases.

Another benefit is the high-performance, scalable platform for business infrastructures that permits robust event-driven applications. In addition, the new system and methods harness the full capabilities of high-performance multi-processor servers of a security processing system such as the one implemented in Nasdaq®.

Importantly as well, additional subscribers can be added in a non-obtrusive fashion when cross system needs grow, thus providing a high performance, scalable, and reliable system overall. Moreover, the new system and methods also provide added security, automatic fault tolerance to local redundant servers, manual disaster recovery strategies as well as robust state of the art network security.

The details of one or more embodiments of the invention are set forth in the accompanying drawings and the description above. Other features and advantages of the invention will be apparent from the following detailed description, and from the claims.

### BRIEF DESCRIPTION OF THE DRAWINGS

FIG. 1 is a block diagram of a securities processing system.

FIG. 2 is a messaging subsystem of the securities processing system of FIG. 1.

FIG. 3 is a diagram of a dissemination process of the messaging subsystem of FIG. 2.

FIG. 4 is a flow chart of an active messaging queuing process of the dissemination process of FIG. 3.

FIG. 5 is a flow chart of a standby messaging queuing process of the dissemination process of FIG. 3.

FIG. 6 is a block diagram of a dissemination file record.

FIG. 7 is a block diagram of a information bus process.

FIG. 8 is a block diagram of a Dissemination Service (DS) module.

FIG. 9 is a flow chart of a process in the DS of FIG. 8.

FIG. 10 is a flow chart of a DS translator process.

FIG. 11 is a flow chart of a translator task process.

FIG. 12 is a block diagram of two DS API processes to set and send a publish message.

FIG. 13 is a block diagram of a DS parser program.

FIG. 14 is a flow chart of a parser function.

FIG. 15 is a flow chart of another parser function.

FIG. 16 is a flow chart of another parser function.

FIG. 17 is a flow chart of another parser function.

FIG. 18 is a flow chart of the DS parser program of FIG. 13.

FIG. 19 is a flow chart of a translator task process.

FIG. 20 is a flow chart of a retransmit function.

### DETAILED DESCRIPTION

Securities System Architecture

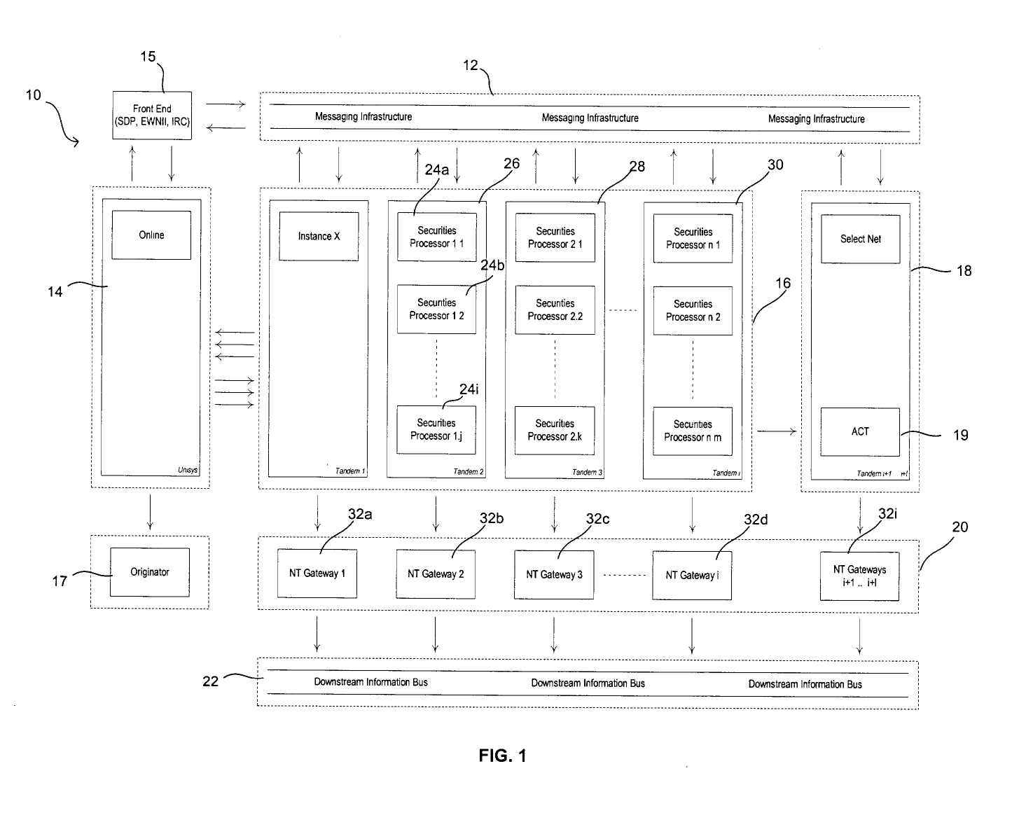

Referring to FIG. 1, a securities processing system 10 includes a messaging infrastructure module 12, an online interface 14, a security parallel processing module 16, a trading services network module 18 (e.g., SelectNet®), a network (NT) gateway module 20, and a downstream information bus module 22. The online interface 14 is in data communication with a front-end module 15 and data originator module 17. The front-end module 15 sends and receives unsorted financial trading and quote data to and from the messaging infrastructure 12.

The securities processing system 10 is a multi-parallel processing system with one or more security processors 24a, 24b, and 24i (collectively, security processors 24) per security processor nodes 26-30. The securities processors 24a-24i are high-performance multi-processor servers. The nodes 26-30 are single hardware platforms for securities host applications and software. The securities processing system 10 includes communication interfaces for data transfer, namely, the messaging infrastructure module 12 which is an upstream infrastructure for data exchange, the downstream information bus module 22, the online interface 14, and the trading services network module 18. The downstream information bus module 22 is coupled to the NT gateway module 20, which includes [generic name] an example of which is TIB®/NT [spell out] Gateways 32a-32i (collectively, Gateway 32). The downstream bus module 22 performs downstream data dissemination to users via a communication interface or bus referred to as the TIB® (Teknekron Information Bus) information bus, provided by TIBCO®, Inc., of Palo Alto, Calif. The online interface 14 is implemented as a Unysis® interface. The trading services network module 18 processes directed securities orders and further includes an automated confirmation transaction (ACT) module 19 used for clearing and comparing securities orders and quotes.

The instruction sets and subroutines of the security parallel processing module 16 and an order routing system are typically stored on a storage device connected to a system server. Additionally, the trading services network module 18 stores all information relating to securities trades on the storage device which can be, for example, a hard disk drive, a tape drive, an optical drive, a RAID array, a random access memory (RAM), or a read-only memory (ROM).

In certain implementations, the system server includes at least one central processing unit and main memory system. Typically, the system server is a multi-processing, fault-tolerant system that includes multiple central processing units that each have a dedicated main memory system or share a common main memory pool. While being executed by the central processing units of the system server, the order routing system and multiple instantiations of the security parallel processing module 16 reside in the main memory system of the system server. Further, the processes and subroutines of the security parallel processing module 16 and the order routing system may also be present in various levels of cache memory incorporated into the system server.

Still referring to FIG. 1, the downstream bus module 22 performs caching services using the cache services architecture provided by the embedded multi-parallel processing system of the securities processing system 10. The downstream bus module 22 provides a mechanism for consolidating and disseminating data to subsequent downstream applications. The downstream bus module 22 uses one message format for like events from different hosts provide a consolidated view by publishing and subscribing data to downstream users. The data dissemination is available on the cache services infrastructure with differing subject titles.

In networked-based distributed computing environments such as the securities processing system 10, the use of publish/subscribe (i.e., “multicast” capabilities) is critical. In a “publish/subscribe architecture,” a data source or publisher can transmit information to a non-specific destination, and multiple downstream users or subscribers (i.e., data sinks) can simultaneously subscribe to a flow of information through connection to a source-specific multicast address. Thus, the multicast concept of a “publish/subscribe” approach allows the securities processing system 10 to have a data source to publish data, which is encoded by “subject,” such that data sinks can subscribe to information by data type as opposed to a specific data source. The downstream bus module 22 is, thus, a critical core message distribution system that uses middleware to provide the ability for data sources (publishers) to send data, and data sinks (subscribers) to request data by any subject type.

Accordingly, the downstream bus module 22 enables real-time messaging needed for robust infrastructures. Moreover, the downstream bus module 22 enables robust event-driven applications to harnesses the capabilities of the security processors 24. Also additional downstream users and subscribers can be added in a non-obtrusive fashion when growth is required.

The cache services of the downstream bus module 22 places all available market and securities data on the downstream bus module 22. This data includes online quotes, market and index statistics, as well as SelectNet® The Nasdaq Stock Market, Inc.

Publish/Subscribe Messaging Subsystem

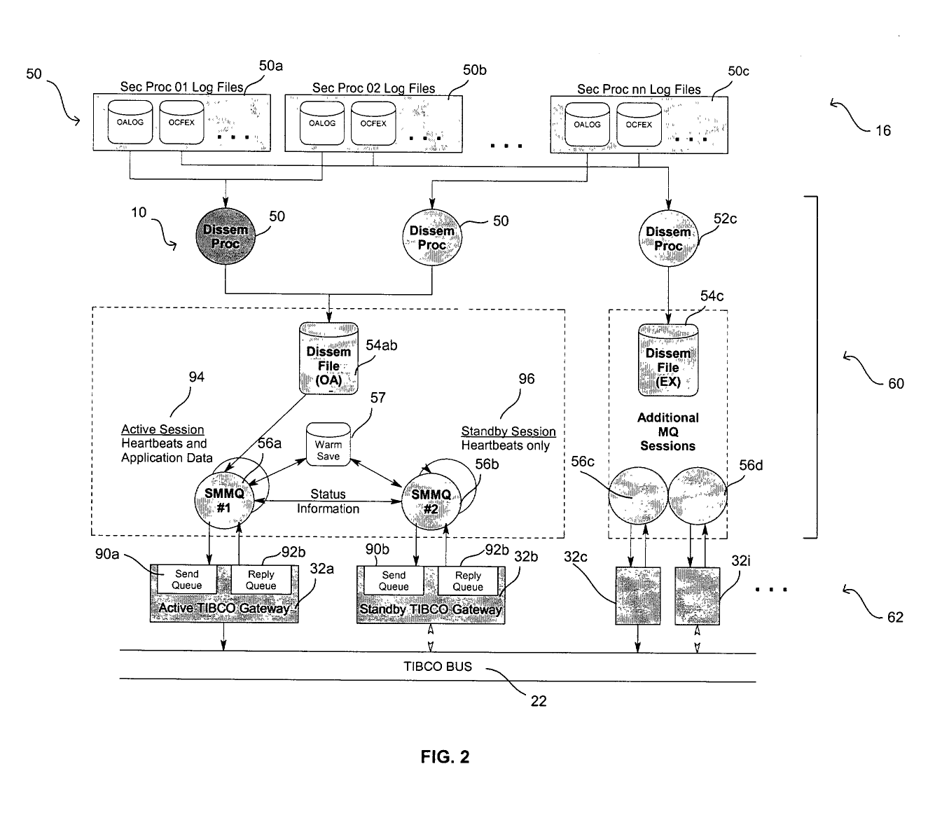

Referring to FIG. 2, a publish/subscribe messaging subsystem 60 of the downstream bus module 22 includes programs designed to provide dissemination of data published by the security processors 24 of FIG. 1. Each security processor 24 is a component of the security parallel processing module 16. The security processor 24 writes dissemination data to a series of log files 50a-50c (collectively, log files 50), some of which have blocked records. Each log is read by a dissemination process 52a-52c (collectively, dissemination process 52) that prepares the data for dissemination and writes the results to a dissemination file 54ab-54c (collectively, dissemination files 54). A single dissemination process 52a, for example, can handle multiple log files, provided they are of the same type. A pair of message queuing processes 56a-56c (collectively, message queuing processes 56) provide a fault-tolerant mechanism for transferring the contents of the dissemination files 54 to the TIB®/NT Gateway 32 of the downstream bus module 22, running on an NT Server 62.

The dissemination process 52, the dissemination files 54, and the message queuing processes 56 are components of the publish/subscribe messaging subsystem 60, and the TIB®/NT Gateways 32 are components of the NT server 62. The components of the publish/subscribe messaging subsystem 60 are described in greater detail below.

Publish/Subscribe Subsystem Components

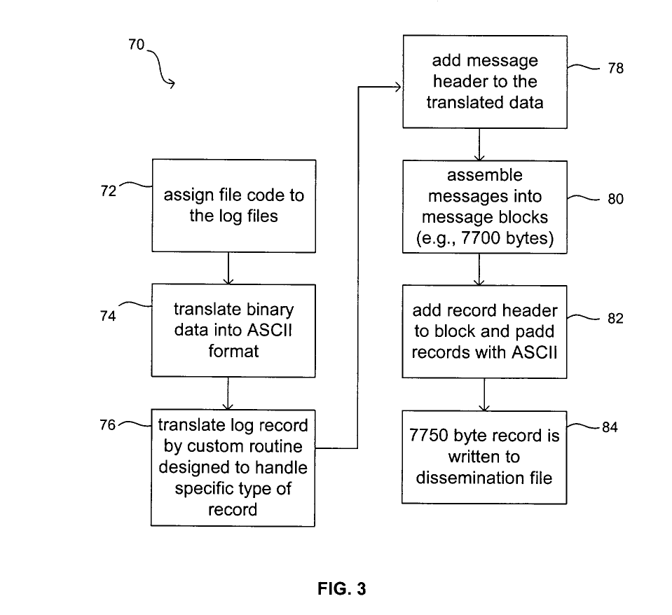

Referring to FIG. 3, the dissemination process 52 of the publish/subscribe messaging subsystem 60 reads the dissemination log files 54 produced by the security processors 24 and prepares them for dissemination. The dissemination process 52 includes a process 70 that handles N, e.g., 1 to 100 log data files of the same type.

The process 70 can handle blocked or unblocked data in the log files 54. The presence of blocked data is indicated by a file code assigned (72) to the log file (e.g., file with codes ending in 66 are blocked). A record blocking library is used to unblock the data. The binary data of the log files 54 is translated (74) into ASCII format with each type of log record being further translated (76) by a custom routine specifically designed to handle that record type. A message header is added (78) to the translated data and the messages are assembled (80) into message blocks of up to 7700 bytes, including the block header. A record header is also added (82) to the block and the records are padded with ASCII space characters to make the record header 7750 bytes in length. The 7750 byte record is written (84) to a dissemination file. Although not shown, multiple dissemination processes can share the same file provided they the processes are handling the same type of log file 54.

The other component of the publish/subscribe messaging subsystem 60 is the message queuing processes 56. The message queuing processes 56 are responsible for queuing blocks of security messages to a queue located on the NT Server 62. The data transport mechanism is based upon a message queuing (e.g., Geneva MQ) product, running over TCP/IP. Software running on the NT Server 62 is the TIB®/NT Gateway 32 of the downstream bus module 22, running on an NT Server 62. The TIB®/NT Gateway 32 converts the data into self-describing format and publishes the results to the downstream bus module 22.

As still illustrated in FIG. 2, message queuing processes 56 include two fault tolerant message queuing process pairs 56a and 56b. Each process pair 56a and 56b runs with a backup process and is configured for each dissemination file 54a and 54b, respectively (shown as dissemination file 54ab in FIG. 2). Each process pair 56a and 56b writes to a queue located on a different NT Server. For example, the message process pair 56a writes to a send queue 90a and reads from a reply queue 92a, whereas message process pair 56b writes to a send queue 90b and reads from a reply queue 92b.

Only one of the processes 56a and 56b transfers application data. The process 56 that transfers data is known as the active process 94. The second process is known as the standby process 96. Both processes 94 and 96 maintain message queuing session with the NT Server 62 and both send update messages known as “heartbeat messages” and receive “heartbeat response messages,” which indicate that the TIB®/NT Gateway 32 software is operational and running.

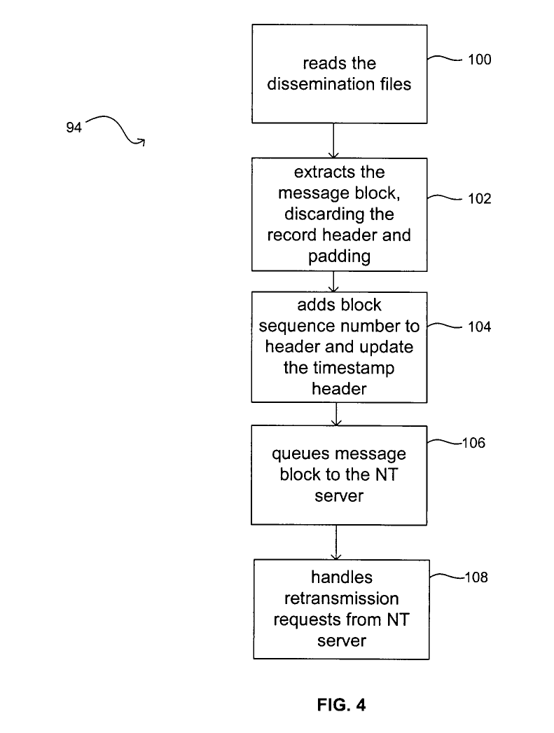

Referring to FIG. 4, in addition to exchanging “heartbeats,” the active process (94) reads (100) the dissemination files 54 (e.g., 7750 bytes per read), extracts (102) message block by discarding the record header and any padding, and adds (104) a block sequence number to the block header and updates a timestamp found in the header. The dissemination file is not updated, and only the data is transmitted. The active process queues (106) the message block to the NT Server 62 and handles (108) retransmission requests from the NT Server 62.

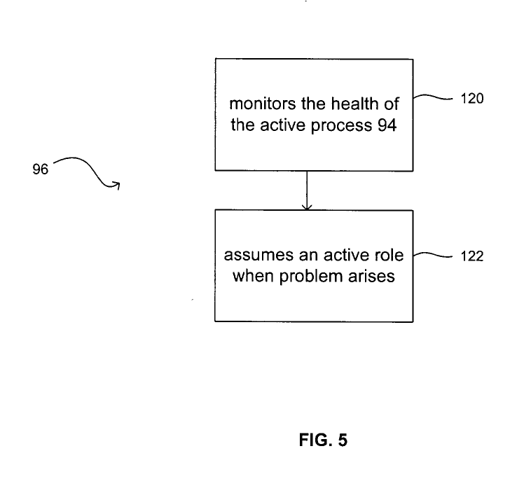

As shown in FIG. 5, the standby process 96 monitors (120) the health of the active process and assumes (122) the active role if a problem is detected.

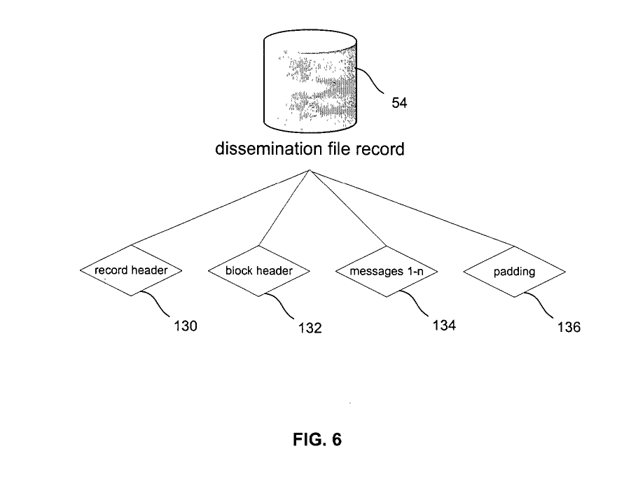

The dissemination file 54 is an unstructured enscribe file, as opposed to a structured file, i.e., key sequenced, entry sequenced or relative. An unstructured file is used so that the maximum size block (e.g., 7700 bytes) can be assembled and written to the dissemination file 54 in a single operation. The maximum size for a structured file is limited to 4096 bytes. All records written to the dissemination file 54 are exactly 7750 bytes in length. The records are padded with ASCII spaces as required prior to writing them to the file. The fixed length allows a message block to be located for retransmissions and/or troubleshooting by multiplying the block sequence number, assigned by the process 96 by 7750 to calculate the byte offset of the record. 7750 bytes were chosen to accommodate the need for a record header, which is not transmitted, and still allow for up to 7700 bytes of data in the message block. Referring to FIG. 6, each dissemination file 54 has a dissemination file record that includes the following data elements: a record header 130, a block header 132, a message header (1-n) 134, and padding 136.

The record header 130 is a variable length header carrying the offset and length of the message block and “warmsave” information 57 (FIG. 2) (“warmsave” data is defined as a dynamic system data that a process is the master of, and that cannot be recreated from field indication inputs), used by the dissemination process 52 (FIG. 2) for recovery operations. The record header 130 is not sent to the TIB®/NT Gateway 32 of the downstream bus module 22.

The block header 132 is a header for carrying a blank block sequence number field that is filled in by the processes 94 and 96 when the block is transmitted. The entire message block (e.g., header and messages) can be up to 7700 bytes in length.

The messages header (1-n) 134 has a header that includes the length of the message expressed in “little Endean” format, the category and type codes of the message and information that identifies the log file, and the location in the log file, where the message originated. The message data of the message header has a log file data that is translated into ASCII format and placed after the message header. In addition, the trailer of the message header is noted as a “UU,” giving the visual indication of the break between messages. The padding of the record is done with ASCII Space Chars to arrive at 7750 bytes in length. The padding is not sent to the TIB®/NT Gateway 32.

Components Supporting the Publish/Subscribe TIB® Information Bus

The overall approach and architectural foundations for the publish/subscribe messages are described below.

Security Cache

The security cache (a.k.a., “Last Value” cache or LVC) serves two primary functions. It spans the delta and verbose publish/subscribe buses by listening for the inbound delta messages and creating the verbose messages for subsequent publication. The security cache also supports issue related queries. Similar to all downstream processors, one of the objectives of the security cache is to offload processing from the host, thus increasing the overall processing speed.

Aggregate Depth at Price (ADAP) Cache Server

The ADAP cache server disseminates quote updates, closing reports, issue and emergency halt messages, and control messages related to issues transacted via the system 10. The ADAP cache server disseminates the best three price levels and aggregated size on both the bid and ask side for securities, for example. The data disseminated from the ADAP cache server must be delivered on a real-time basis, in the same timeframe as data delivered to a market workstation platform.

NQDS-Prime Cache Server

The NQDS-prime cache server disseminates aggregated quote updates (e.g., three best bid and three best ask prices and aggregated sizes) as well as the individual market participant quotes and sizes which have been aggregated at each of these prices. The data disseminated from this product is delivered on a real-time basis, in the same timeframe as data delivered to a market workstation platform.

Query Server

The query server (a.k.a., “order query server”) supports query scans from users wishing to know the current detailed state of transactions submitted to the market system 10 including the history of executions against their submitted orders. The query server offloads processing from the host to improve overall processing speed. The queries are predominantly low frequency of occurrence scans with voluminous output. The query server also responds to queries from subscribers for query scans reflecting summary state information totaled by the market participant ID.

TIB® Dissemination Service (TDS)

The TIBCO® Dissemination Service (a.k.a., “TDS”) is a Tandem component that provides a publishing interface between the system 10 and an NT gateway service that is responsible for the publication of downstream messages onto the downstream bus module 22. SuperMontage® writes the output from processing business transactions in a fixed format to a publication trigger file, and the TDS formats the output for delivery via a third party software (e.g., Geneva MQ) to the TIB®/NT Gateway 32.

In addition, the publish/subscribe messaging subsystem 60 of the downstream bus module 22 (FIG. 2) is a TIB® messaging subsystem which supports the system 10 infrastructure by providing a publish/subscribe methodology that allows the downstream applications to subscribe to those messages that provide input data that is required for their particular business functions. Thus, the TDS provides a mapping mechanism between fixed format messages such as trigger file format written by system application programs and formatted messages expected by the gateway running the TIBCO message routing software.

This methodology allows the host trading system to publish the results of a business function out to a gateway message server that formats the data and push the message out onto a TIB information bus such as the downstream bus module 22. The gateway servers also alleviate the host of all retransmission responsibilities to the subscriber systems.

The messages have been designed on a logical basis to date, i.e., each business function includes its own single message publication (i.e., quotes, aggregate quotes, orders, etc.). When the system design stipulates that one single business event (e.g., quote update) is to result in the publication of one large TIB® message, the messages are not retransmitted.

In the TDS environment, the SuperMontage® architecture calls for two downstream bus modulees. The first takes the minimal data set published by the host and the second transports fully populated messages to the downstream subscribers. The first bus logically sits just below the SuperMontage® host. This first bus takes the messages output from the host and transports them to a broadcast consolidation server (BCS). The BCS is responsible for streaming the broadcast data to the appropriate Application Programming Interface (API) interface connections. The LVC takes the message broadcast onto the first downstream bus module and fill in all fields within the message that were not filled in by the host. This fully populated message is published onto the second downstream bus module to satisfy all of the other SuperMontage® Downstream Applications (i.e., NQDS, NQDS Prime, Query Server, MDS, etc.). The query server supports a set of high volume subscriber queries.

The current suite of messages include quote entry, quotes, aggregate quotes, orders, executions, events, issue management, market administration, position maintenance, entitlements, administration, and tier codes.

The interfaces that are used in the system 10 architecture include gateways to primary downstream bus module (e.g., the delta bus), primary downstream bus module to BCS, Primary downstream bus module to LVC (security cache), primary downstream bus module to query server, LVC to QDS for level 1 and NQDS feeds, LVC to NQDS prime server, LVC to ADAP server, LVC to IDS/Data Capture Server (DQS) for MDS, LVC to SDR Server. Other messages are published by the hosts to support additional cache servers, vendor feeds and BCS broadcasts. They are defined as part of the cache services design.

System 10 applications publish several messages, including quote updates and orders, which are disseminated by the cache servers for downstream applications, e.g., workstation software. System 10 applications are expected to produce published messages in fixed format data structures, though the downstream applications expect messages in a self describing message (i.e., SDM) format of tokens and the value pairs. Thus, a mapping mechanism to map fixed format messages into SDM is used. SDM is further described below.

TIB® Information Bus Process

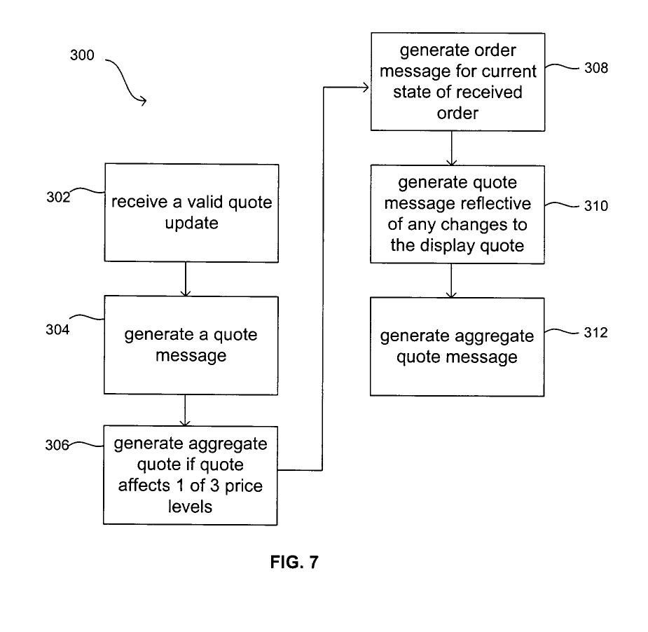

Referring to FIG. 7, in a TIB® information bus process 300, the messages provided from the system 10 host to all the downstream applications are illustrated. The system 10 host provides the changed data values for each of the messages and is reliant upon the Last Values Cache to qualify the messages it receives so that all of the downstream applications that require fully qualified messages are satisfied.

In the process 300, after receiving (302) a valid quote update, a quote message is generated (304), which is reflective of the new display quote. Then, an aggregated quote message is generated (306) for delta values if the received quote affects one of the three price levels on either side of the quote. Moreover, the receipt of a valid order results in the generation (308) of an order message supplying the current state of the received order, if not immediately executed, a quote message is also generated (310) reflective of any changes to the display quote due to the unexecuted order as well as generation (312) of an aggregate quote message. The suite of messages is described in greater detail below.

The quote message provides all the necessary data for the system NT servers (e.g., BCS servers) to satisfy their business requirements. The BCS receives the quote message to construct the necessary IQMS format broadcast record such that the subscriber workstations can view the market quote of a security. Further, the quote message also provides the new inside data, if necessary. For example, the QDS server uses the quote message to provide the data to both the NQDS and level 1 subscriber feeds.

The quote entry message shows what quote update information is presented to the system 10 host and any rejection information that the quote entry generates. The aggregate quote message provides the prices and aggregate size for the three best price levels on both the bid and the ask side of the quote for a single security. The message may be constructed to handle up to any number, e.g., six (6) price levels and aggregate sizes on both sides of the quote. In addition, the system server uses this message to construct its vendor feed of the three (3) best price levels and aggregate sizes.

All states and modifications to an order are reflected in the aggregate quote message. For example, the aggregate quote message is published when an order is received, and subsequently republished if the order was not executed, but had the order size reduced. It is republished when the order is partially executed against, detailing the current state of the remainder of the order. The query server accumulates these order messages to satisfy any order scan queries requested by the subscriber workstation.

The execution message is published for every execution that occurs within the system. The query server accumulates this data for any subscriber workstation queries for the status of orders. For events, the host publishes the events when any system event occurs, such as market open or close or an emergency market condition.

For issue management, messages are published for each modification to an issue in the issues database. This data is used to validate the correct application of an update to the database and for surveillance purposes. For market administration messages, such messages are published whenever a supervisor initiates a market related action such as an issue halt or a market event. The information is also captured for surveillance purposes.

For position maintenance, this message is published whenever a supervisor produces or modifies an MP's position information. The information is also captured for surveillance purposes. In the event of entitlements, the message is used to move entitlements related data from the host to the appropriate downstream applications, and in the case of administration, the message is published whenever a supervisor initiates a broadcast message. For tier codes, the message publishes the tier codes table to the BCS.

Self-Describing Messages

The self describing messages (SDM) are ASCII textual information. SDMs do not use binary or other data types. SDMs include tokens, delimiters, and data. Tokens are words, mnemonics, or other short-hand text used to identify data. The list of valid tokens is maintained in a message token file. Delimiters separate the tokens, data, and messages. Data is plain text that represents the values of the message components.

SDMs are variable in length and include delimiters, one subject, and one or more records. Each record has one or more key-fields.

The delimiters are from the ASCII control character set and are used as follows:

| Code | Character | Name/Meaning | SDM Usage |
|---|---|---|---|
| 1 | SOH | Start of heading | Start of message/subject |
| 2 | STX | Start of text | Start of key-fields/end of subject |
| 3 | ETX | End of text | End of key-fields |
| 4 | EOT | End of transmission | End of message |
| 28 | FS | File separator | Start of name |
| 29 | GS | Group separator | Start of type/end of name |
| 30 | RS | Record separator | Start of value/end of type |

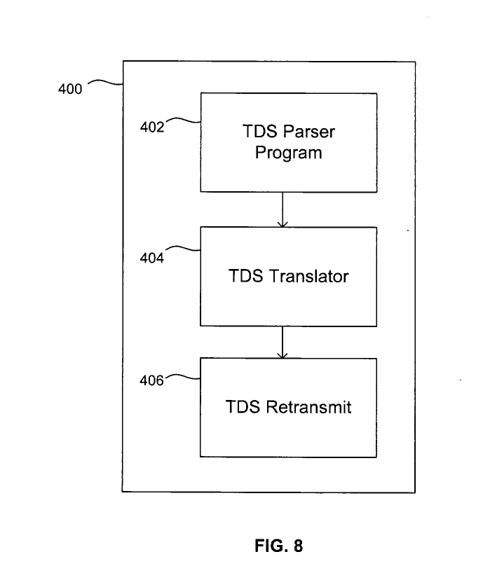

Referring to FIG. 8, a TDS module 400 includes three programs, a TDS parser program 402, a TDS translator 404 and a TDS retransmit 406. The TDS parser program 402 creates and maintains static information about the required mapping between fixed format trigger files and SDM formats. The TDS retransmit program 406 retransmits earlier published messages in response to requests from the gateway. The TDS module 400 also provides an API of functions for writing a message to the publish trigger file.

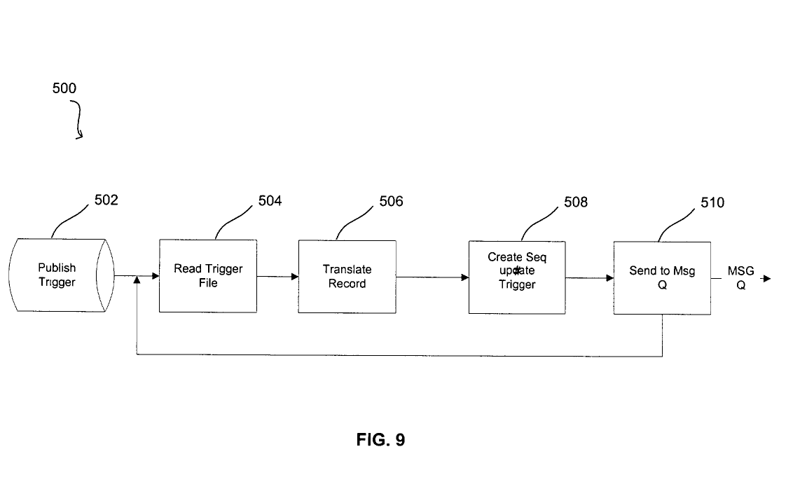

Referring to FIG. 9, a TDS process 500 is illustrated. The TDS parser program 402 publishes (502) the trigger files, which are subsequently read (504). The records are then translated (506), the sequence number is produce and the trigger record is updated (508), and sent (510) to the message queue.

During translating 506, a TDS translator program 404 may be an online program. The program translates fixed format trigger records written by several system 10 programs to SDM, and writes to the outbound message queue. The TDS translator program 404 gets the mapping between the fixed format trigger records and SDM format from the swap file. The swap file is created by the TDS parser program 402. The TDS translator program 404 and the gateway software are based on the SDM format specifications to decipher the messages.

In addition, the TDS translator program 404 provides a mechanism to publish messages to downstream bus module 22 via the gateway using a number of files, as outlined in the table A below:

TABLE A

| File Name | File Type | Create | Read | Updated | Delete |
|---|---|---|---|---|---|
| Publish Trigger | Key Sequenced | | Y | Y | |
| TDSSwap | Key Sequenced | | Y | | |

The TDS translator program 404 also requires write access to the outbound MQ series queues to the gateway.

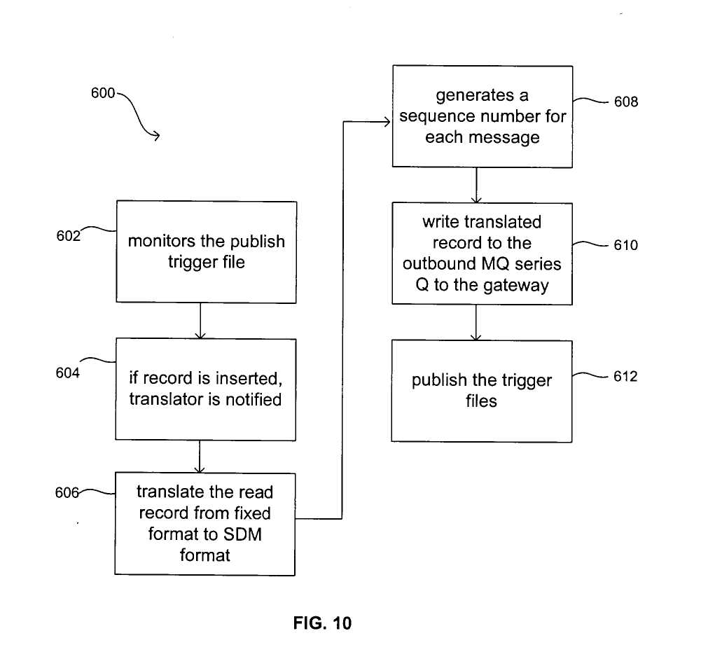

Referring to FIG. 10, a TDS translator process 600 is described. The TDS translator program monitors (602) the publish trigger file. If a record is inserted in the publish trigger file, the translator program 404 is notified to read the record (604). Next, the read record is translated (606) from the fixed format to SDM format by using the translation information from the swap file. The translator program 404 also generates a sequence number for each message (608). The translated record is then written to the outbound MQ series queue to the gateway (610).

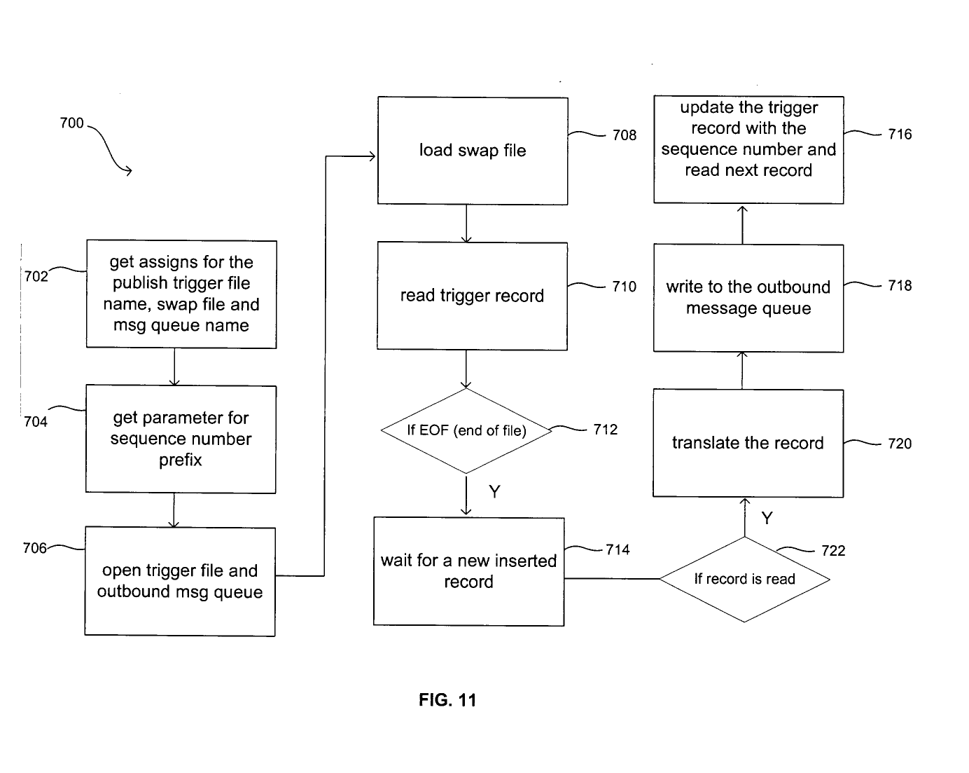

Referring to FIG. 11, a flow chart for a translator task process 700 illustrates the files and queues accessed by the TDS translator program 404. The translator program 404 gets assigns (702) for the publish trigger file name, swap file name, outbound message queue name. Subsequently, the translator program 404 get parameter for the sequence number prefix (704), open trigger file and outbound message queue (706), and loads the swap file (708). The program 404 then reads a trigger record (710), and if a EOF is reached (712), the program 404 waits for a new inserted record (714). If a record is read (716), the program translates the record (718), and proceeds to write to the outbound message queue (720) to update the trigger record with the sequence number (722) and read next record (724).

Therefore, the TDS message translator program 404 translates the publish trigger record and creates the SDM formatted message to be sent to the gateway, which in turn creates a TIBCO® message and publishes the message using the downstream bus module.

TDS Application Programming Interface (TDS API)

The TDS API provides a set of function calls. The function calls provided by the API allow system 10 application programs to generate a publish message, set the values for the publish message and then write the message to the publish trigger file. The TDS translator program 404 (see FIG. 8 above) reads the messages from the publish trigger file to translate and send to the gateway. The gateway publishes the messages on the TIB® information bus.

The TDS API sets all the necessary header information in the message, e.g., MessageID, SendTime, necessary delimiters, etc. All other fields are set to pre-defined initial values indicating that the fields are not set and thus should not be included in the message. The API also validates whether all the required fields in a message have been set by the program and may validate the values of the fields against some predefined criteria. The validation is performed before writing the message to the publish trigger file. The API makes sure that only validated messages are written to the publish trigger file.

In general, all TDS API functions require a unique message ID to specify which publish message is being operated on. A program may operate on more than one publish message. For example, the TDSInitialize( ) function returns the initial message ID, and calls to all other TDS API Library functions operating on that message provide the very same ID. Further, all TDS API functions return an error code upon completion. Zero always indicates a successful completion.

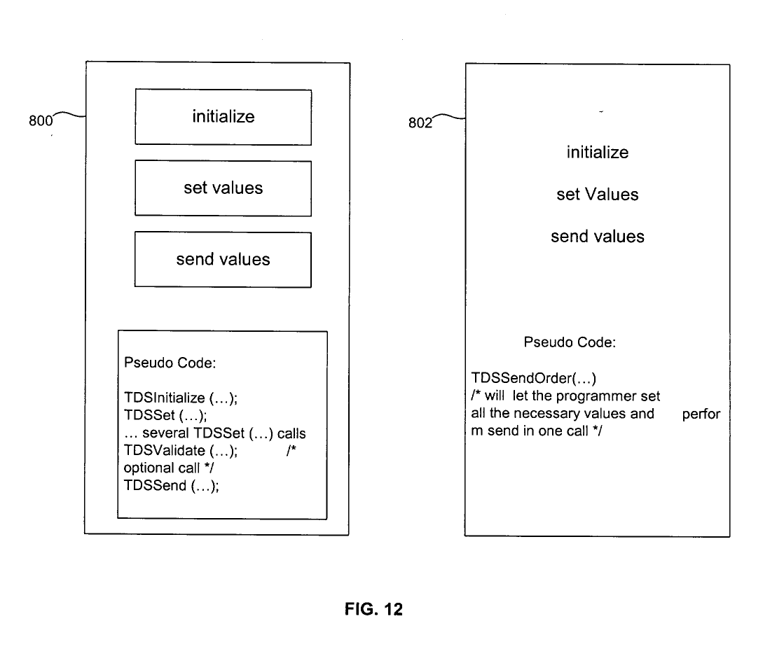

Referring to FIG. 12, the TDS API also provides two separate mechanisms to set and send a publish message. A first process 800 provides separate calls to initialize, set the values and then send. A second process 802 provides a quick call that performs all three functions in one call (i.e., initialize, set values and send). The quick function call allows a programmer to send a publish message with all required fields in a call. One or more API functions are provided for each type of publish message.

The following are examples of TDS API functions, namely, (1) TDS initialize for initializing a new message, (2) TDS set for setting values of message fields, (3) TDS validate for validating that all required values are set and message is ready to send, and (4) TDS send for writing the message to the publish trigger file.

TABLE B
TDSInitialize
(short TDSInitialize( short *pnMessageId, short nMessageId )

| Parameter | I/O | Description |
|---|---|---|
| PnMessageId | o | Returns the unique message identifier that must be |
| | | passed to other TDS functions when operating on this |
| | | message |
| NMessageId | i | ID of the message to be created. A predefined set of |
| | | message Ids will be provided. E.g., |
| | | ORDER_PUBLISH, QUOTE_PUBLISH etc. |
| Returns | | 0 if successful; Otherwise the error code |

TABLE C
TDSSet (short TDSSet( short nMessageId, short nField, void *pvFieldVal)

| Parameter | I/O | Description |
|---|---|---|
| nMessageId | i | Unique message identifier returned by TDSInitialize( ) |
| nField | i | The Field in the message to be set. A predefined list of |
| | | fields for each message type will be provided for |
| | | usage. E.g., SYMBOL_ID, BID_PRICE |
| pvFieldVal | i | The value to be set in the message field. |
| Returns | | 0 if successful; Otherwise the error code |

TABLE D
TDSValidate (short TDSValidate( short nMessageId )

| Parameter | I/O | Description |
|---|---|---|
| NMessageId | i | Unique message identifier returned by TDSInitialize( ) |
| Returns | | 0 if successful; Otherwise the error code |

TABLE E
TDSSend (short TDSSend( short nMessageId, short nPTFnum)

| Parameter | I/O | Description |
|---|---|---|
| nMessageId | i | Unique message identifier returned by TDSInitialize( ) |
| nPTFnum | i | The file number for the publish trigger file. |
| Returns | | 0 if successful; Otherwise the error code |

For instance, the TDSInitialize function must be called to initialize a message before any other TDS functions can be called. And the TDSValidate function is an optional function. The function may be used by the program before calling the TDSSend function. However, the TDSSend function validates the fields before writing to the trigger file.

TDS Parser

As described above, the TDS provides a mapping mechanism between fixed format messages (trigger file format) written by a system 10 application program and SDM formatted messages expected by the gateway running the message routing software. As one of the three main programs of TDS, the TDS parser program 402 (FIG. 8) generates mapping information by parsing dictionary files (not shown) created by a DDL. The format for each trigger file message to be published is defined in the DDL. During the parsing of the dictionary files, the TDS parser program 402 maintains the information about message records, message record fields and the TIBCO® token for each field in three files. The files are TDS Message Map file, TDS Field file and TDS Token file.

The TDS parser program 402 also creates the memory swap file. The memory swap file is used by the TDS translator program 404 and other utility programs to dump messages in a desired format. The TDS parser program 402 maintains the map between fixed format trigger file records for the publish messages and Self Describing Message (SDM) format used by TIBCO® message routing software.

The TDS parser program 402 uses the files described below:

TABLE F

| Filename | Filetype | Create | Read | Update | Delete |
|---|---|---|---|---|---|
| TDSToken | Key Sequenced | | Y | Y | |
| TDSMap | Key Sequenced | | Y | Y | |
| TDSFields | Key Sequenced | | Y | Y | |
| TDSSwap | Key Sequenced | Y | | Y | Y |
| DDL DICTs | Key Sequenced | | Y | | |

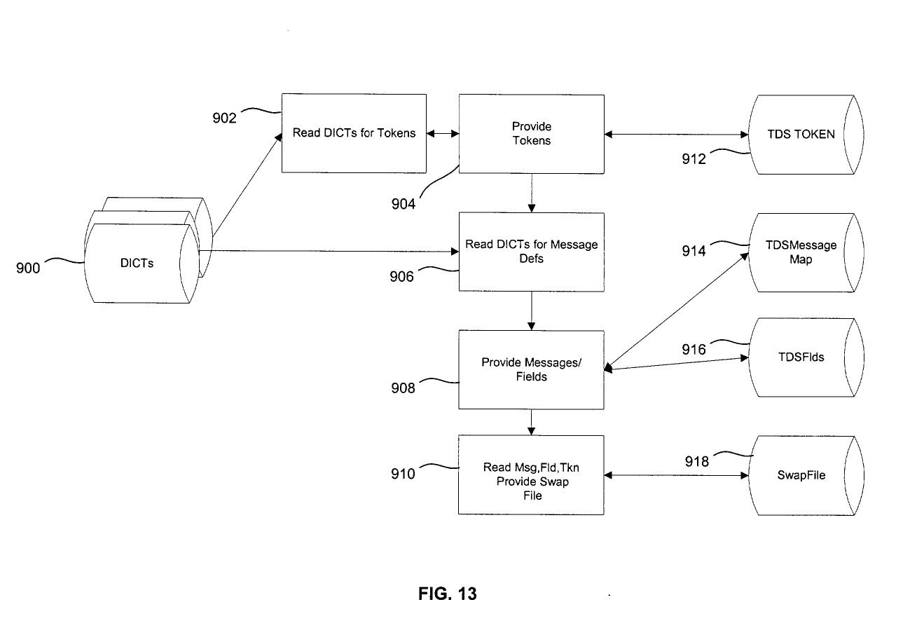

Referring to FIG. 13, the interaction of the TDS parser program 402 with data files is illustrated. The TDS parser program 402 uses the DICT files 900 produce by the DDL to parse information related to the TDS Tokens 912, TDS Map 914 and TDS Fields 916. First, the DICTS are read for tokens (902), and tokens are produced (904). Subsequently, DICTS can be read (906) for message definitions, and the parser program then creates messages/fields (908), which leads to reading of the message, field, token, and generation of the swap file (910). Therefore, after producing or updating of the TDSToken 912, TDSMap 914 and TDSFields files 916, the TDS parser program 402 loads the tokens and message maps from these files in a swap file. The swap file 918 is used by the TDS translator program 404.

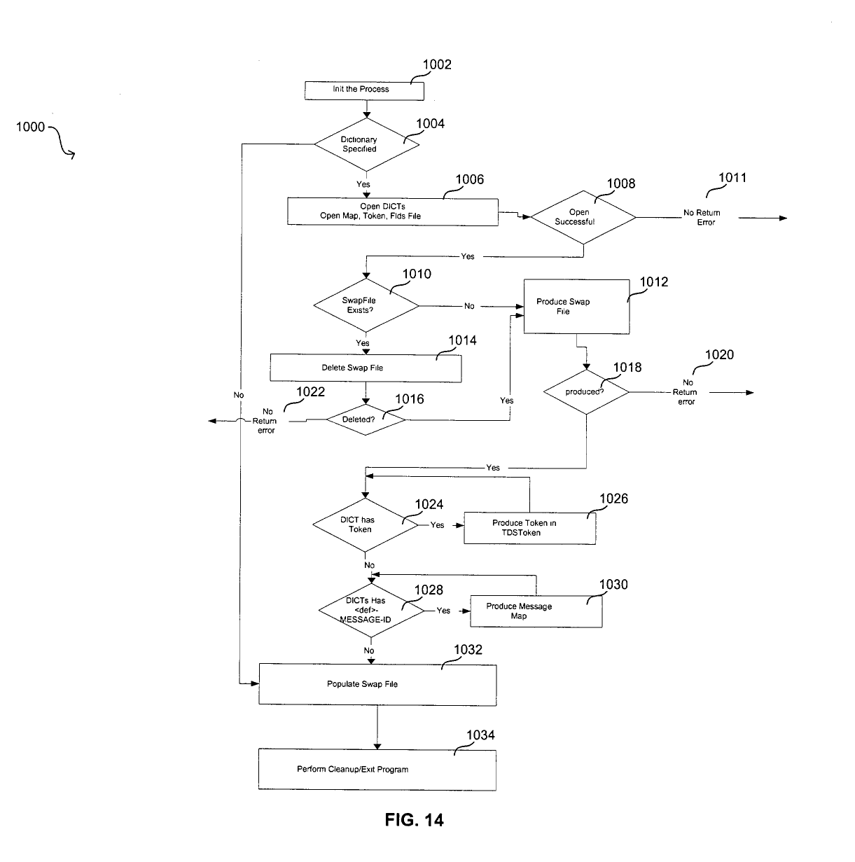

The process flow diagrams for the parser functions, Parser main( ), Create Token( ), CreateMessageMap( ), PopulateSwap( ), are illustrated in FIGS. 14-17.

Referring to FIG. 14, a Parser main( ) function 1000 initializes the process (1002). After the DICTS is specified (1004), if the specification has returned, the DICTS is opened (1006), and if the specification is has not been completed, the swap file is populated (1032). Once the DICTS is opened (1006) and the open has been successful (1008), the function checks if the swap file exists (1010). If the swap file does not exist, the swap file is created (1012). If the swap file exists, the swap file is deleted (1014). If the deletion is not complete, an error message is generated (1022). If the deletion is complete, the function returns back to the creation of a swap file (1012). After checking the status (1018), if the swap file has not been created, an error message is generated (1020).

If the swap file has been successfully generated, the function checks for tokens (1024) and if DICT has no tokens, the function again checks if the DICT has a message ID (1028). Without the message ID, the swap file is populated (1032). If the DICT has tokens, the function also generated token in the TDS token (1026). Once the DICT has a message ID, the message map is finally generated (1030). And after the swap file has been populated, the Parser main( ) function performs cleanup and exits (1034).

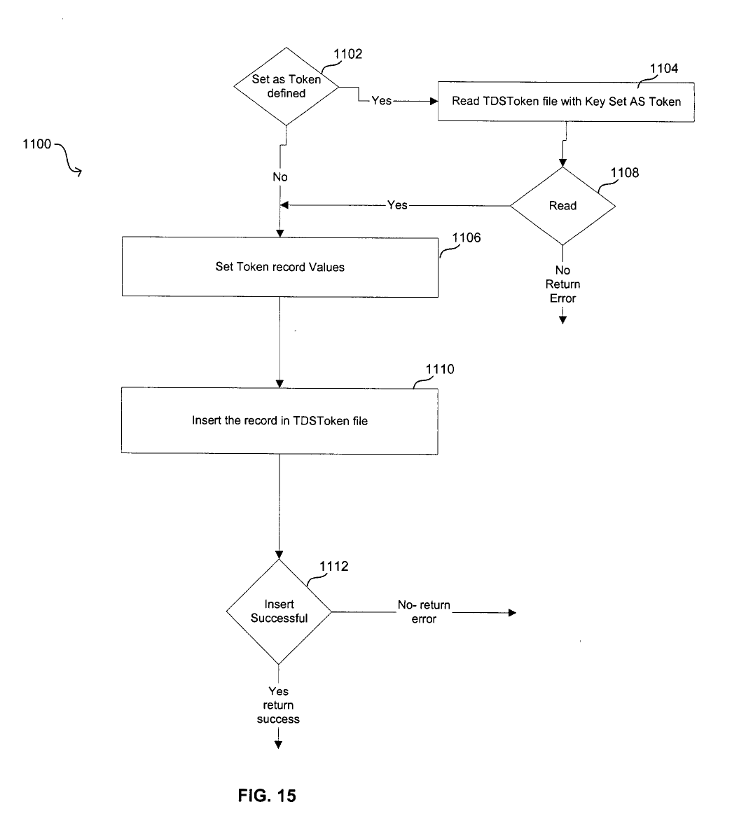

Referring to FIG. 15, another parser function, Create Token( ) 1100 is illustrated. The function first checks if the Tokens have been defined (1102). If no, the function sets the token record values (1106) and if yes, the function reds TDS tokens file with key set as tokens (1104). If the tokens can be read, no error messages are generated (1108). Upon setting the token record values (1106), the function inserts the record in the TDS token file (1110) and checks if the insert has been successful (1112).

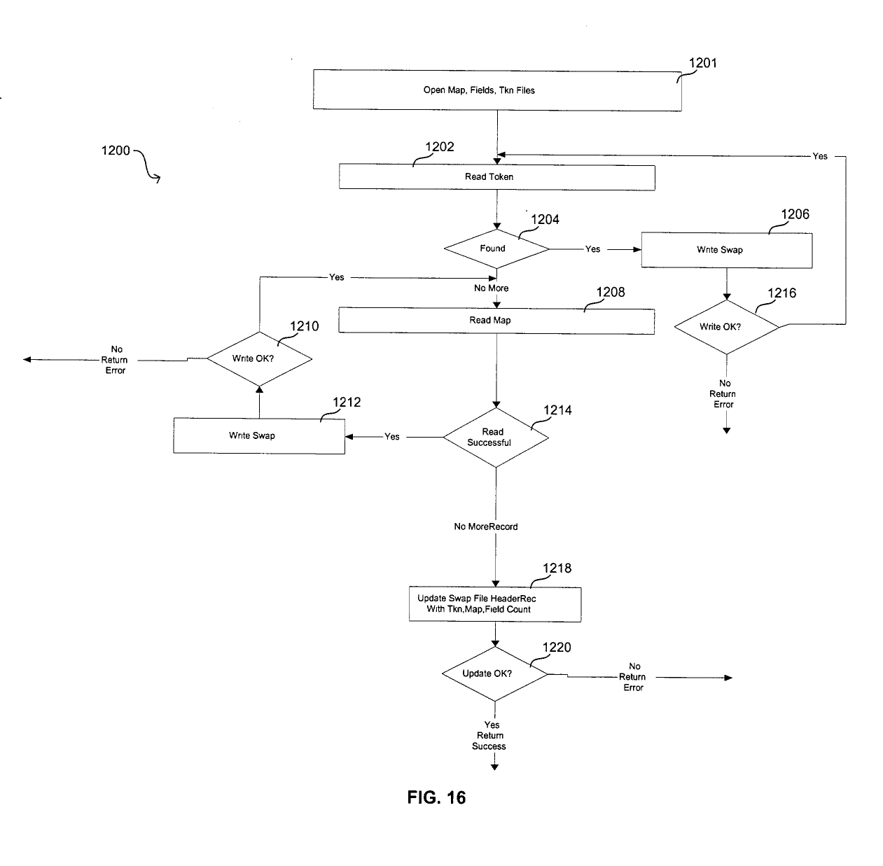

Referring to FIG. 16, a CreateMessageMap( ) parser function 1200 begins by opening map, fields and token files (1201). The function reads the tokens (1202) and checks if the tokens have been found (1204). If yes, the function performs a swap function (1206) and if not the function proceeds to read the map (1208). If upon writing the swap, the write is determined to be successful (1216), no error messages are generated. After the function reads the map (1208), the function checks to determine if the read has been successful (1214). If yes, the function writes the swap (1212) and again determines if the write is successful as well (1210). If no, an error message is generated and if yes, the function loops back to read the map (1208). After the read has been determined to be successful (1214), no more records remain and the function proceeds to update the swap file header with token, map, and field counts (1218). Then, the function checks to determine if the update has been successful (1220). If yes, a return successful message is generated and if no, an error message is generated.

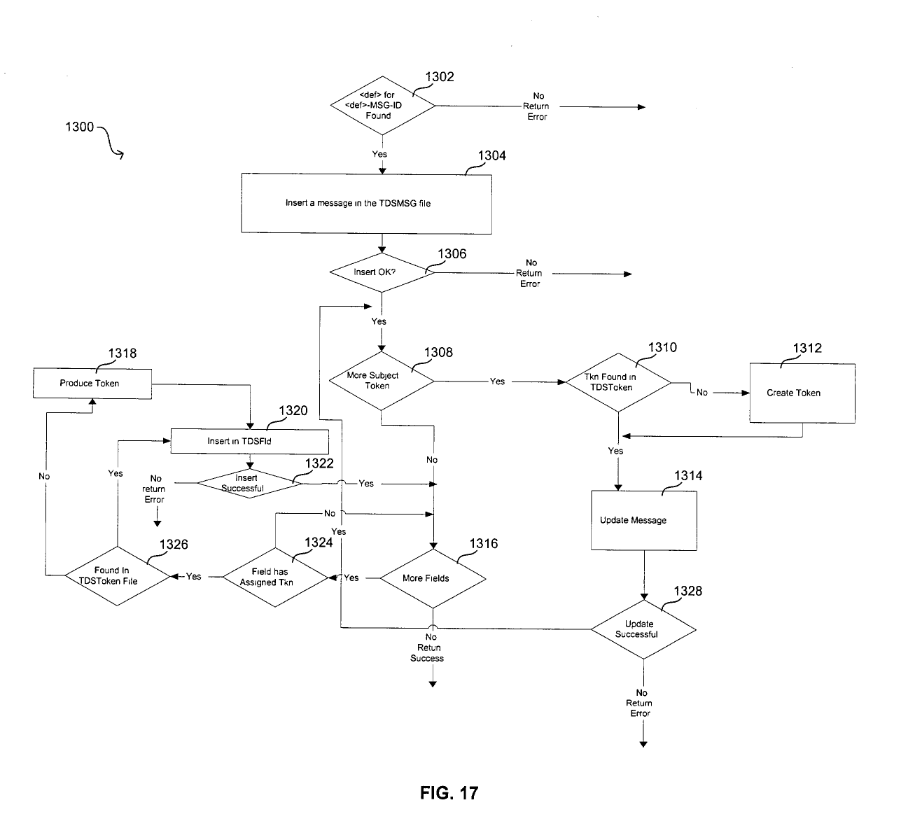

Referring to FIG. 17, the last parser function, PopulateSwap( ) function 1300 initiates by checking for message IDs (1302). If the message ID is found, the function inserts a message in the TDSMSG file (1304). If the insert has been successful (1306), the function requests more subject tokens (1308), and if no, an error message is generated. If no further subject tokens are available, the function requests more fields (1316). If more fields are available, the field has assigned tokens (1324) and the function determines and checks for TDToken files (1326). If no TDSToken are found, more tokens are generated (1318). Thereafter, the function inserts tokens in the TDSfield (1320) and checks to determine if the insert has been successful (1322). If yes, the function loops back to check if more fields are available (1316). If more subject tokens are in fact available (1308), the function checks to determine if tokens are found in the TDSToken (1310). If yes, the function updates the message and if no, the function generates more tokens (1314). If the update has been successful (1328), no error messages are generated.

TDS DDL

The system 10 programs generate fixed record messages for the purpose of publishing on the downstream bus module. The fixed record message is translated in SDM format with subject name and TIBCO® tokens before publishing on the downstream bus module. To automate the process of generating and maintaining TIBCO® publish message map, the publish messages are defined in a specific pre-defined DDL form.

For each publish message, the DDL source is required to have the following statements:

(1) A constant ending with the <def-name>.

MESSAGE-ID should be defined in the DDL source.

The value of the constant shall be four letter numeric. For example,

CONSTANT ORDER-PS-MESSAGE-ID VALUE “0201 ”; and

(2) A Message definition with <def-name>. For example,

DEF ORDER-PS HELP “NASD.ORDER.<SECURITY>”.

Each field of the message is defined with the field name data type along with the token name and conversion in the HELP clause. For instance:

TABLE G

| | | | CON- |
|---|---|---|---|
| FIELD-NAME | DATA-TYPE | TOKEN-NAME | VERSION |
| DEF | TYPE CHARACTER 10 | HELP “SN” | |
| SEQUENCE- | | | |
| NUMBER | | | |
| DEF SECID | TYPE CHARACTER 16 | HELP “SECID” | |
| DEF ASK- | TYPE PRICE-DEF | HELP “ASKP” | “PRICE” |
| PRICE | | | |

Message Map Record

The message map records associate publish trigger record message types with subject addresses. The message field records associate trigger file fields with tokens. Additionally, the required data conversion function can be specified. Field information such as offset, length, type, occurs, and the like, will be extracted from the dictionary as needed and maintained in the message field file. The message map record contains information about the DDL (data description language) dictionary location where the message map record is defined, and the subject tokens and the number of fields included in the publish trigger record.

Message Fields Record

The Message fields records associate publish trigger record fields with the TIBCO® tokens. Field information such as offset, length, type, occurs, the like, is kept in the message field record. One message field record may contain up to 50 fields of a publish trigger record. If the publish trigger record contains more than 50 fields, multiple message field records are created each consisting of maximum of 50 fields. The primary key consisting of message ID and record number is used to access the information about publish trigger record's fields.

Message Token Record

A token record is populated for each TIBCO® token that may be used in a system 10 message. The tokens are the SUBJECT and KEY-FIELDS in the SDM sent to the downstream bus module. Each token is assigned a unique token number so that the references to the token can be made by this number. The token number allows the name to be changed at a later time. Since the token number needs to be determined, the insertion of a token requires determining the last token inserted. A token may be “based-on” another token. This means that the attributes for a token can be acquired from another token already defined.

Memory Table Structure

The TDSSwap File provides immediate service upon startup or failure recovery. Rather than reading through the files, the memory table file is ready made and all that is necessary is to allocate the memory area using the data provided in the memory table.

TDS Retransmit

As described above, system 10 applications publish several messages including quote updates, orders etc to be disseminated by the cache servers for downstream applications e.g., workstation software. The TDS provides a mapping mechanism between fixed format messages (trigger file format) written by a system 10 application program and SDM formatted messages expected by the gateway running the TIBCO® message routing software. As the third of the TDS' three main programs, the TDS retransmit program 406 (FIG. 8) is an online program.

The TDS retransmit program 406 translates fixed format trigger records, written by system 10 programs, to SDMs and writes to the retransmit message queue. The TDS retransmit program 406 responds to the retransmit requests from the gateway. The gateway may request to retransmit a range of messages by specifying the beginning and end sequence numbers, transmitted earlier by the TDS retransmit program 406. The TDS retransmit program 406 facilitates a mechanism for the gateway to request missing messages. The gateway identifies the missing messages based on the sequence number it receives with each message.

The TDS retransmit program 406 is required to provide a mechanism to retransmit to the gateway. The gateway may have missed the messages because of transport, protocol or any other problems. The TDS retransmit program 406 uses the files outlined below:

TABLE H

| Filename | Filetype | Create | Read | Update | Delete |
|---|---|---|---|---|---|
| Publish Trigger | Key Sequenced | | Y | | |
| TDSSwap | Key Sequenced | | Y | | |

The TDS retransmit program 406 requires write access to the outbound MQ Series queues to the gateway. The TDS retransmit program 406 also requires read access to inbound MQ series queue from gateway to receive retransmit request.

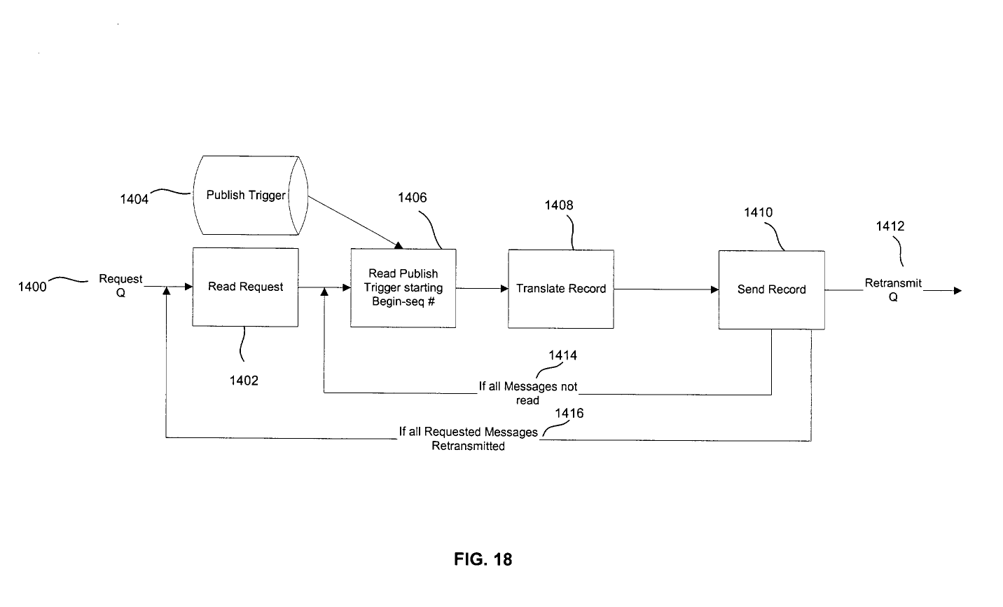

Referring to FIG. 18, the interaction and access of the TDS parser program 402 with TDS files and queues are illustrated. The TDS retransmit program 406 begins by requesting a queue (1400). Thereafter, the TDS retransmit program 406 initializes a read request (1402) simultaneously with a publish trigger request (1404). The next step involves the read publish and trigger file request beginning with a sequence number (1406). Once the read publish trigger request has been completed, the record is translated (1408). Subsequently, the record is sent (1410), and the TDS retransmit program 406 retransmits the queue (1412). If all the message are not read, after the TDS retransmit program 406 has sent the record, the process loops back to read publish trigger request (1414). If all the requested messages have been successfully retransmitted after the TDS retransmit program 406 has sent the record, the process loops back to the initialization step prior to the read request (1416).

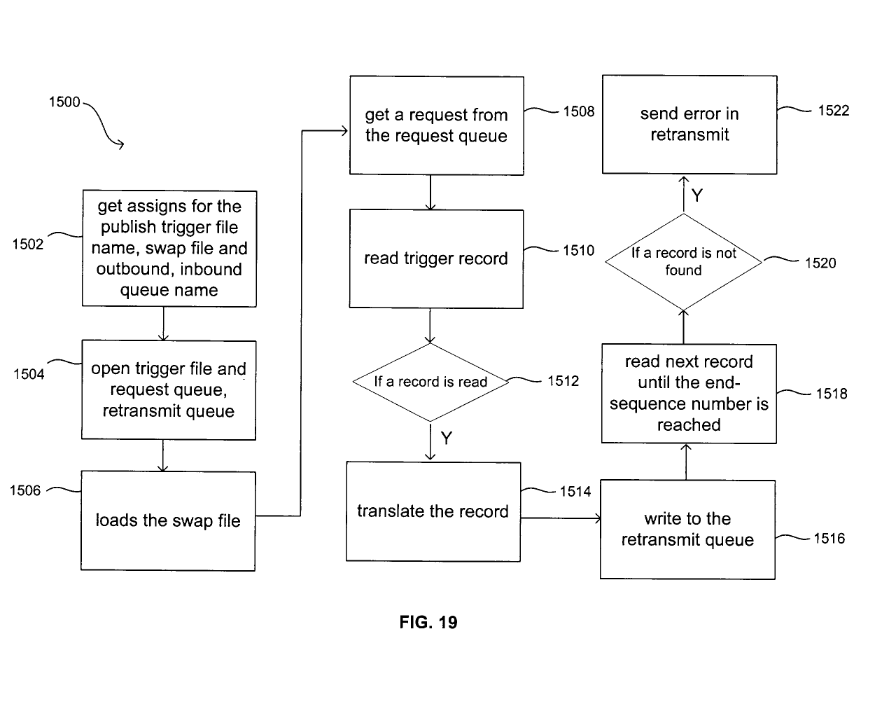

Referring to FIG. 19, a flow chart for a translator task process 1500 illustrates the files and queues accessed by the TDS retransmit program 406. The TDS retransmit program 406 gets assigns (1502) for the publish trigger file name, swap file name, inbound and outbound message queue name. Subsequently, the TDS retransmit program 406 open trigger file, request queue and retransmit queue (1504), and loads the swap file (1506). The TDS retransmit program 406 can then read a get a request from the request queue (1508), read the publish trigger file starting begin-sequence number and read the trigger (1510), and if the record has been read (1512), translate the record (1514), then write to the retransmit queue (1516) and read the next record until the end-sequence number is reached (1518). If the record is not found (1520), send error in retransmit (1522).

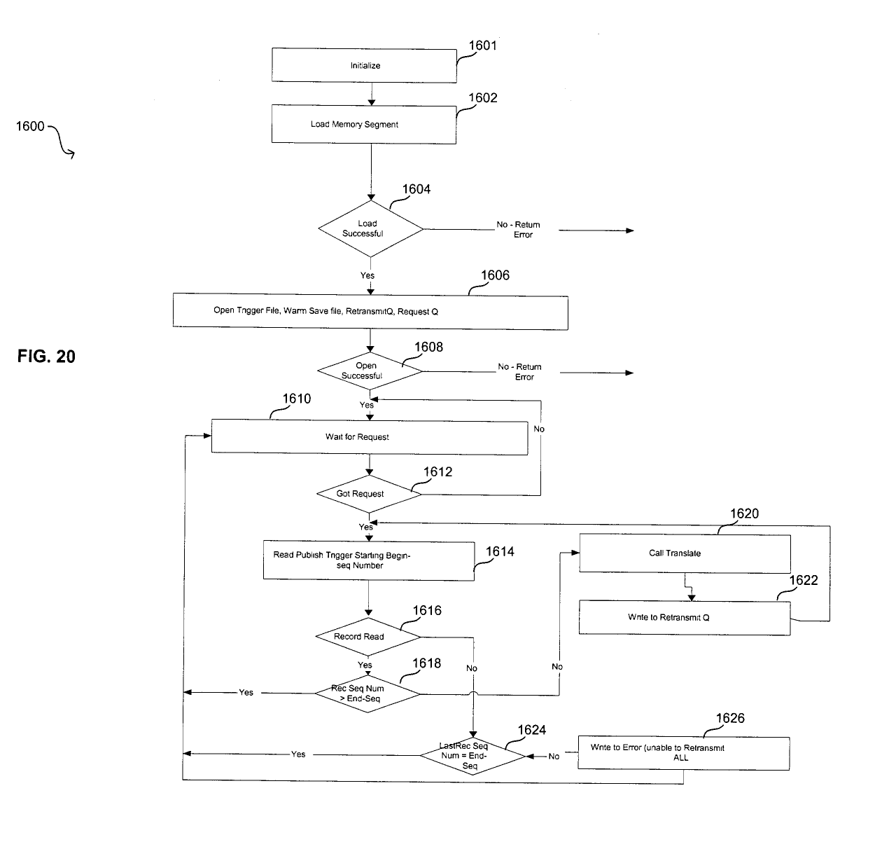

Referring to FIG. 20, a Retransmit main( ) function 1600 initializes the process (1601) by loading a memory segment (1602) and determines if the load has been successful (1604). If the load has not been successful, an error message is generated. If the load has been successful, the function opens trigger files, warm save file, retransmit queue and request queue (1606). Then, the function determines if the open has been successful (1608). If no, an error message is again generated. If yes, the function executes a wait for request signal (1610). Subsequently, the Retransmit main( ) function determines if the request has been received (1612). If yes, the function proceeds to read publish trigger starting with the beginning sequence number (1614). The function also determines if the record has been read (1616) and the record sequence number has an end of sequence field (1618). If yes, the function loops back to wait for a request (1610). If no, the function executes a call translate (1620) and then writes to a retransmit queue (1622). If the function cannot be read (1616), the function determines if the last record sequence number equals the end of the sequence. If no, the program generates an error message that it the function is unable to retransmit all (1626).

What is claimed is:

1. A system for disseminating data, the system comprising:
a gateway server having cache memory;
a processing module coupled to the gateway server capable of making a subscription request requesting data on a subject to be sent to a subscriber application; and
a communications module for receiving a message from a plurality of upstream network gateway servers, subscribing a plurality of downstream gateway servers to receive the message, and broadcasting the message to the plurality of downstream gateway servers.

2. The system of claim 1, wherein the communications module is a bus interface between the plurality of upstream gateway servers and the plurality of downstream servers.

3. The system of claim 1, further comprising an intermediary software component having a plurality of functions invoked by the intermediary software component to perform data exchange functions.

4. The system of claim 2, wherein the bus interface comprises a plurality of subroutines for data message formatting.

5. The system of claim 2, wherein the bus interface includes subject-based addressing.

6. The system of claim 2, wherein the message comprises quote data.

7. The system of claim 2, wherein the message comprises aggregate quote data.

8. The system of claim 2, wherein the message comprises order data.

9. The system of claim 2, wherein the plurality of upstream network gateway servers comprises messages formatted into fixed format data structures.

10. The system of claim 9, wherein the plurality of upstream network gateway servers broadcast the message.

11. The system of claim 9, further comprising self describing messages mapped from fixed format data structure messages.

12. The system of claim 11, wherein the self describing messages comprise textual information.

13. The system of claim 1, wherein the plurality of upstream network gateway servers transmit the message to a broadcast consolidation server.

14. The system of claim 13, wherein the broadcast consolidation server broadcasts the message to the plurality of downstream gateway servers.

15. The system of claim 14, wherein the plurality of downstream gateway servers comprises workstation applications.

16. The system of claim 15, wherein the workstation applications provide a plurality of function calls to generate the message.

17. The system of claim 16, wherein the workstation applications set a plurality of values for the message.

18. The system of claim 17, wherein the workstation applications write the message to a publish trigger file.

19. The process of claim 18, wherein a translator reads the message from the publish trigger file to be translated and published to the plurality of downstream network gateway servers.

20. A dissemination process comprising:
receiving a message from a plurality of upstream network gateway servers;
subscribing a plurality of downstream gateway servers to receive the message; and
broadcasting the message to the plurality of downstream gateway servers.

21. The process of claim 20, wherein the message comprises quote data.

22. The process of claim 20, wherein the message comprises aggregate quote data.

23. The process of claim 20, wherein the message comprises order data.

24. The process of claim 20, wherein the plurality of upstream network gateway servers formats the message into fixed format data structures.

25. The process of claim 24, wherein the plurality of upstream network gateway servers pushes the message to be broadcast.

26. The process of claim 25, further comprising mapping the fixed format data structure messages into self describing messages.

27. The process of claim 26, wherein the self describing messages comprise textual information.

28. The process of claim 20, further comprising transmitting the message from the plurality of upstream network gateway servers to a broadcast consolidation server.

29. The process of claim 28, wherein the broadcast consolidation server broadcasts the message to the plurality of downstream gateway servers.

30. The process of claim 29, wherein the plurality of downstream gateway servers comprises workstation applications.

31. The process of claim 30, wherein the workstation applications provide a plurality of function calls to generate the message.

32. The process of claim 31, wherein the workstation applications set a plurality of values for the message.

33. The process of claim 32, wherein the workstation applications write the message to a publish trigger file.

34. The process of claim 33, wherein a translator reads the message from the publish trigger file to be translated and published to the plurality of downstream network gateway servers.

35. A computer program product residing on a computer readable medium having a plurality of instructions stored thereon which, when executed by the processor, cause that processor to:
receive a message from a plurality of upstream network gateway servers;
subscribe a plurality of downstream gateway servers to receive the message; and
broadcast the message to the plurality of downstream gateway servers.

36. The computer program product of claim 35, further comprising instructions to:
to format the message into fixed format data structures.

37. The computer program product of claim 36, wherein the instructions to format the message into fixed format data structures further includes instructions to:
to map the fixed format data structure messages into self describing messages.
